(19) United States
(12) Patent Application Publication
(10) Pub. No.: US 2004/0070971 A1
(43) Pub. Date: Apr. 15, 2004

(54) Multi-lamp illumination system

(75) Inventor: Sean Chang, Taoyuan (TW)

Correspondence Address: BACON & THOMAS, PLLC, 625 SLATERS LANE, FOURTH FLOOR, ALEXANDRIA, VA, 22314

(73) Assignee: DELTA ELECTRONICS, INC., Taoyan County (TW)

(21) Appl. No.: 10/390,791

(22) Filed: Mar. 19, 2003

(30) Foreign Application Priority Data
Oct. 9, 2002 (TW) 91123390

(51) Int. Cl. F21V 7/00

(52) U.S. Cl. 362/241; 362/247

(57) ABSTRACT

A multi-lamp illumination system comprises a reflector, a plurality of light sources and light-condensing devices. The reflector is part of an ellipsoidal reflector with a first and a second focal point provided. By means of the light-condensing devices, the light emitted from the light sources passes through the first focal point and then focuses at the second focal point of the ellipsoidal reflector.

### BACKGROUND OF THE INVENTION

1. Field of the Invention

The invention relates to a multi-lamp illumination system, and more particularly, to a multi-lamp illumination system that uses part of an ellipsoidal reflector for combining different light sources.

2. Description of the Related Art

FIG. 1 shows a prior dual-lamp illumination system 100 comprising a rectangular prism 102, two lamps 104 and 106, and parabolic reflectors 108 and 110 arranged corresponding to the lamps. In FIG. 1, the solid line that indicates the optical path is used for describing the operating principle of the system. Referring to FIG. 1, the reflectors 108 and 110 are both parabolic, thus the light emitted downwards from the lamp 104 is reflected to the point C on the rectangular prism by the reflector 108, and is again reflected by the rectangular prism 102, so that the output beam of the lamp 104 is directed into a desired direction. For the light emitted upwards from the lamp 104, after having been reflected the first time by the reflector 108 and the second time by the reflector 110, is directed into the desired direction by the rectangular prism 102, while reflected at the point B on the rectangular prism 102. Similarly, the emitted light of the lamp 106 travels in a resembling manner, thus the light emitted from both lamps 104 and 106 produces a combined beam moving towards the desired direction, thereby achieving the purpose of combining different light sources.

However, when the described system combines different light sources, the light emitted upwards from a lamp wick of the lamp 104 must pass the lamp wick of the other lamp 106 again. Since the outer glass wall of the lamp wick is inevitably imperfect in common manufacturing processes, the imperfect glass wall causes an apparent deviation in the optical path, such that the actual optical path shifts to the path as indicated by the dotted line in FIG. 1 rather than the expected one. Referring to FIG. 1, after passing through the lamp wick of the lamp 106, the light deviates and then reflects at the point A on the reflector 110 and the point B′ on the rectangular prism 102, which renders the direction of the output beam oblique. Hence, the actual light path of the illumination system 100 is different from the expected one as originally designed. Therefore, the efficiency of combining different light sources achieved by the prior dual-lamp illumination system is significantly reduced. Also, the oblique light beams reflected by the rectangular prism is not easily controlled and may further become stray lights within the system, which are unfavorable to the utilization of the illumination system.

### SUMMARY OF THE INVENTION

Therefore, the object of the invention is to provide a multi-lamp illumination system capable of achieving high efficiency in combining different light sources without having the aforesaid disadvantages.

The multi-lamp illumination system of the invention includes a reflector, a plurality of lamps and light-condensing devices arranged corresponding to the lamps. The reflector is composed of part of an ellipsoidal mirror with a first and a second focal point provided, and the second focal point is the pre-determined emission point for the multi-lamp illumination system.

In accordance with an embodiment of the invention, the light-condensing device is the reflector of the lamp formed by part of an ellipsoidal mirror, and it is designed such that one of the light-condensing focal points overlaps with the first focal point of the reflector. Thus the emitted light from the plurality of lamps is able to pass through the first focal point by means of the light-condensing devices and then focus at the second focal point.

In accordance with another embodiment of the invention, the light-condensing device is a combination of a parabolic reflector and a lens, wherein the lens is used for focusing the parallel-beams reflected by the parabolic reflector at the first focal point of the reflector.

Through the design provided by the invention using the part of an ellipsoidal reflector and different light-condensing devices, it can combine different light sources efficiently regardless of their number, type or space distribution with only ensuring that the emitted light enters one focal point of the ellipsoidal reflector by various light-condensing devices as described in the embodiments. The invention not only is free from the direction deviation caused by having the optical pass through the light wick twice as in the prior system, but also offers the design for combining light sources used in projection display systems further simplicity and better flexibility.

### BRIEF DESCRIPTION OF THE DRAWINGS

FIG. 1 is a schematic showing a prior dual-lamp illumination system.

FIG. 2 is a schematic showing a multi-lamp illumination system according to an embodiment of the invention.

FIG. 3 is a schematic showing a multi-lamp illumination system according to another embodiment of the invention.

### DESCRIPTION OF THE PREFERRED EMBODIMENTS

Reference of related diagrams shall be given below for better illustrating the embodiments in accordance with the invention.

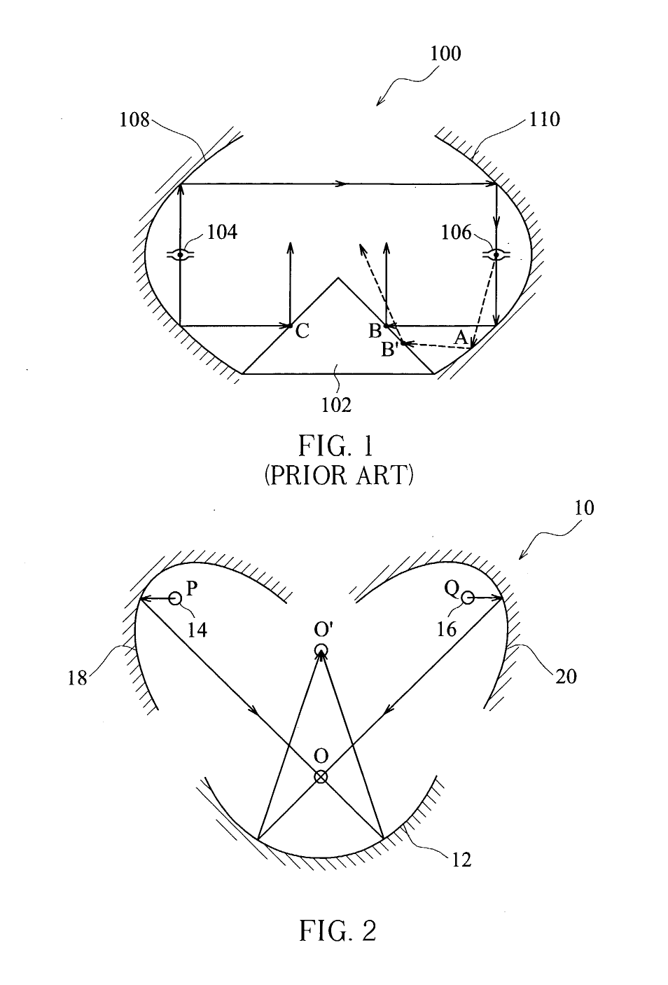

FIG. 2 is a schematic showing a multi-lamp illumination system 10 according to an embodiment of the invention. Referring to FIG. 2, the multi-lamp illumination system 10 comprises a reflector 12, two lamps 14 and 16, and two light-condensing devices 18 and 20. In the embodiment, the lamps 14 and 16 are lamps suitable for use in projection display systems, such as mercury arc lamps. The reflector 12 is part of an ellipsoidal reflector having a first focus O and a second focus O′ and the light-condensing devices 18 and 20 are arranged corresponding to the lamps 14 and 16, respectively. The light-condensing device in this embodiment is also part of an ellipsoidal reflector.

The operating principle of the invention shall be described below with reference to the optical path as indicated in FIG. 2. First of all, based upon the geometric characteristic of an ellipsoid, light emitted from a focus of the ellipsoid 4/8 passes through another focus of the ellipsoid after having been reflected by the surface of the ellipsoid. Therefore, this embodiment begins with disposing the ellipsoidal reflector 12 according to a desired emission point. To be more explicit, referring to FIG. 2, the desired emission point is set to be the second focus O′ of the ellipsoidal reflector 12. Then, according to the position of the first focus O, the ellipsoidal reflectors 18 is arranged in such manner that the point P and the point O each becomes one of the focuses of the ellipsoidal reflector 18, and similarly, the point Q and the point O each becomes one of the focuses of the reflector 20.

Hence, due to the aforesaid geometric characteristic of an ellipsoid, when the lamps 14 and 16 are placed at the points P and Q, the light emitted from both lamps focuses at the same point O by the ellipsoidal reflectors 18 and 20. When the light passes through the point O, because the point Q and the point O′are two conjugate focal points of the ellipsoidal reflector 12 that has been disposed in advance, it is ensured that the light enters the point O′, which is the pre-determined emission point of the illumination system 10, after being reflected at the ellipsoidal reflector 12.

Through the design provided by the invention, light emitted from different light sources is focused at the desired emission point, thus achieving the effect of combining different light sources without resulting the direction deviation of output beams caused by having the light pass through the lamp wick twice.

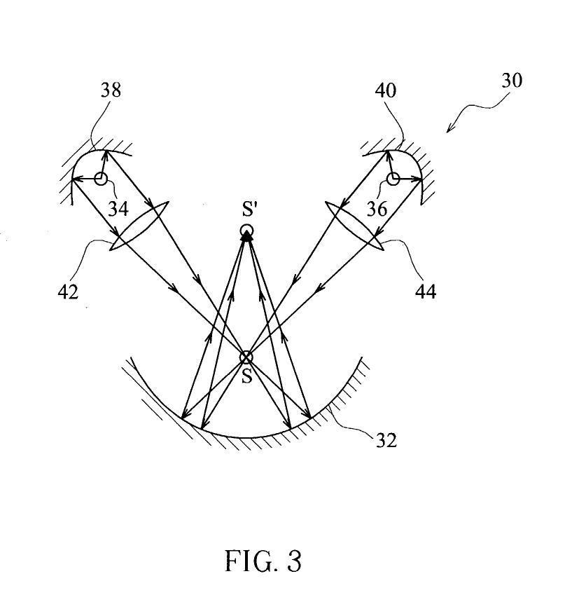

FIG. 3 is a schematic showing a multi-lamp illumination system 30 according to another embodiment of the invention. Referring to FIG. 3, the multi-lamp illumination system 30 similarly disposes a reflector 32 composed of part of an ellipsoidal reflector, and thus two conjugate focal points S and S′ of the ellipsoid are provided. The light-condensing device of this embodiment adopts a combination of a parabolic reflector and a lens. First, the light emitted from the lamps 34 and 36 becomes parallel beams after having been reflected by the parabolic reflectors 38 and 40, and the parallel beams then focus to the focal point S through the lenses 42 and 44. Then, the prearranged ellipsoidal reflector 32 ensures that the beams passed through the focal point S are reflected to another focal point S′, which is the pre-determined emission point of the multi-lamp illumination system 30, and thereby effectively accomplishing the purpose of combining different light sources.

Conclusive from the above, through the design provided by the invention using the part of an ellipsoidal reflector and different light-condensing devices, it can combine different light sources efficiently regardless of their number, type or space distribution with only ensuring that the emitted light enters one focal point of the ellipsoidal reflector by various light-condensing devices as described in the embodiments. The invention not only is free from the direction deviation caused by having the optical pass through the light wick twice as in the prior system, but also offers the design for combining light sources used in projection display systems further simplicity and better flexibility.

The above examples are only illustrative but not limitative. Without departing from the true spirit and scope of the invention, any equivalent variations or modifications made are not be to limited within the above embodiments but shall be embraced within the appended claims.

What is claimed is:

1. A multi-lamp illumination system comprising:
a first reflector composed of part of an ellipsoidal reflector with a first and a second focal point;
a plurality of lamps; and
a plurality of light-condensing devices respectively arranged corresponding to the plurality of lamps; wherein
light emitted from the plurality of lamps focuses at the second focal point after passing through the first focal point by means of the light-condensing devices.

2. The multi-lamp illumination system as described in claim 1, wherein the light-condensing device is a second reflector composed of part of an ellipsoidal reflector, and one focal point of the second reflector overlaps with the first focal point of the first reflector.

3. The multi-lamp illumination system as described in claim 1, wherein the light-condensing device is a combination of a parabolic reflector and a lens, and the lens focuses the light reflected by the parabolic reflector at the second focal point.
